(19) United States
(12) Patent Application Publication
(10) Pub. No.: US 2007/0033138 A1
(43) Pub. Date: Feb. 8, 2007

(54) Worldwide money express service (Business method)

(76) Inventor: Gabriel Ohiochioya Obadan, Pasadena, CA (US)

Correspondence Address: GABRIEL OHIOCHIOYA OBADAN, 1305 N. HUDSON AVENUE, # 3, PASADENA, CA, 91104, US

(21) Appl. No.: 11/198,573

(22) Filed: Aug. 8, 2005

(51) Int. Cl. G06Q 40/00

(52) U.S. Cl. 705/42; 705/39

(57) ABSTRACT

The “Worldwide Money Express Service” is a business method that provides a door-to-door cash delivery service to its Users through a network of independent licensed drivers who receive cash daily from the Service Provider and physically deliver the amount requested by the Users to them in person wherever they may be at any point in time and the Service Provider electronically or physically deducts the amount plus fees from the User's bank or other account before or after the cash delivery.

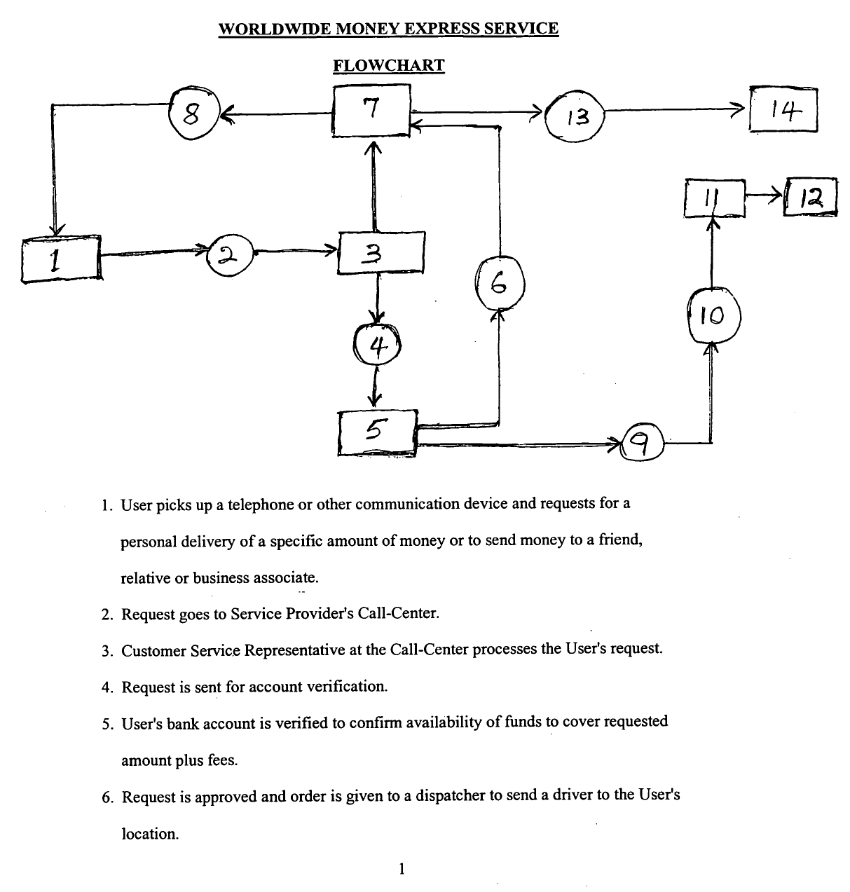

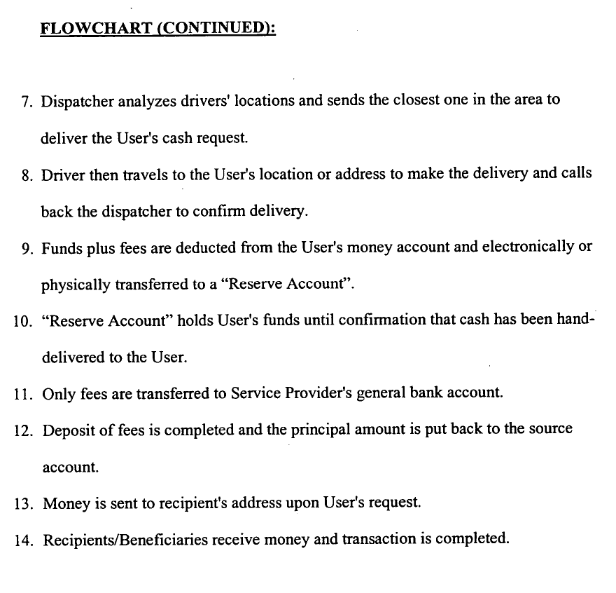

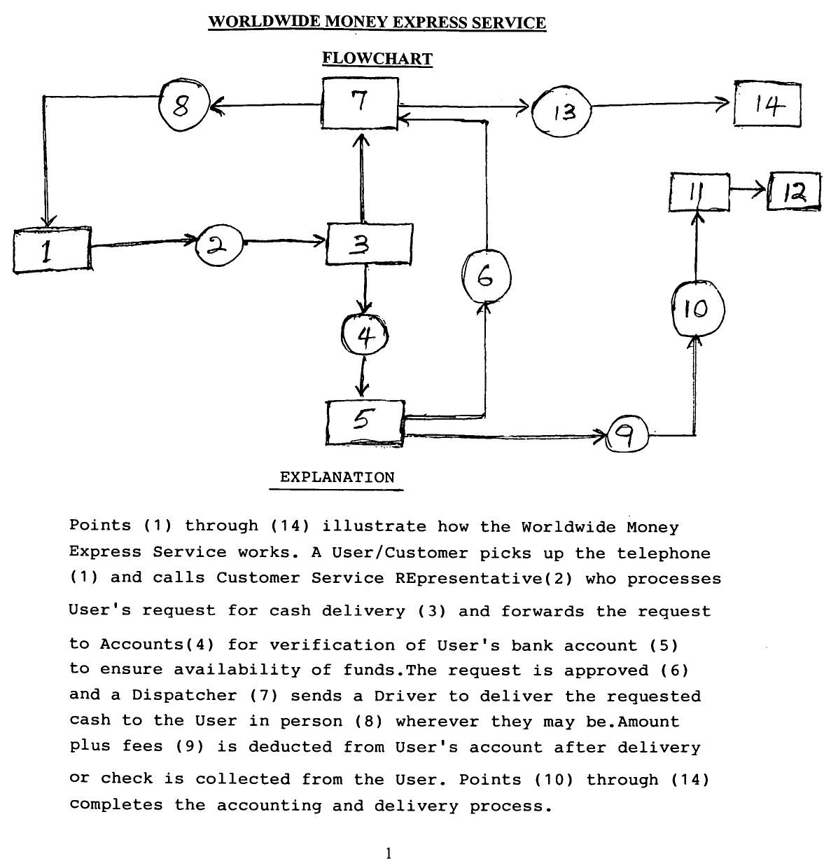

“Worldwide Money Express Service” is a method of doing business which allows a User (Client) of the service to use a telephone, cellular phone, computer, two-way radio, telegram or any other medium of communication to request the personal or physical delivery of money from a Service Provider who will access the User's bank accounts (checking or savings), credit card accounts, investment accounts or any other type of money account and the requested amount of money is withdrawn and physically or personally delivered to the User/Client through a network of independent delivery drivers employed by the Service Provider. The requested amount plus fees are electronically deducted from the User's account by the Service Provider before or after delivery.

For example, a User who does not wish to go to his or her bank or an A.T.M. (Automated Teller Machine) location for whatever reasons, to withdraw cash, can simply pick up a telephone or any other communication device and request the Service Provider to deliver $100 (One Hundred U.S. Dollars) to him or her at a specific location. The Service Provider then processes the order or request by electronically accessing the User's bank account on the Service Provider's database to ensure the User has enough money to cover the transaction, then orders a dispatcher to send one of the Service Provider's drivers to the User's physical location or address to deliver the $100 in person. Each driver is given specific sums of money each day by the Service Provider to distribute to the Users/Clients and the cash is packaged in envelopes in $20, $50 or $100 denominations. The Service Provider uses money from it's own bank account to make the deliveries to the Users and deducts the equivalent amount plus fees from the Users' account later. The Service Provider's drivers can receive personal or business checks from the Users after the cash has been delivered.

Additionally, a User (individual or institution) who wishes to send money to a relative, friend or a business associate who lives in the same city, state, country or abroad can request the Service Provider of the “Worldwide Money Express Service” to deliver a specific sum of money to the friend, relative or business associate at a specified address locally or abroad and the driver employed by the Service Provider is dispatched to deliver the money in person to the beneficiary wherever they may be. Users can also receive money in person if sent by another user of the “Worldwide Money Express Service”. Each transaction is regarded as completed after the driver employed by the Service Provider has physically handed over the requested cash to the User/Customer or their beneficiary and the amount requested plus a fee, say 10% of the principal, has been electronically deducted from the User's bank, credit or other financial account or a check received to cover the transaction. The User is registered with the Service Provider as a client or customer and the business relationship is terminated by the User, by communicating such intention, or by the Service Provider, where the User is considered irresponsible or fraudulent. The Service Provider can also deduct funds from the User's account before the delivery and deposit the money in a “Reserve Account” until the transaction is completed.

The “Worldwide Money Express Service” is designed to provide maximum convenience, time-saving and safety to its Users, individuals or institutions, who for many different reasons are not able to physically go to banks, A.T.M. locations, other financial institutions or the neighborhood Western Union office to get cash. It gives Users the flexibility of taking care of other urgent matters in their lives when time is of the essence and they can not physically do two things at the same time. It provides the User personal safety, especially at night when going to an A.T.M. location is particularly dangerous and the banks have already closed for the day or weekend.

Other services provided by the “Worldwide Money Express Service” include the granting of short-term unsecured personal or business loans which the User can request for over the telephone or other medium, and the requested loan amount is physically withdrawn from the Service Provider's bank account and taken to the User's home, office, workshop, store, hotel room or wherever the User may be at that point in time. Such loans are repaid over a specific period of time by electronic deduction of the principal plus specified interest by the Service Provider of the “Worldwide Money Express Service”. All services are carried out 24 hours of the day and 7 days of the week. The network of independent professional or licensed drivers used to make personal deliveries to the Users or Clients may or may not be bonded and are not required to wear any uniforms to prevent them from being targets for thieves.

Each day, the drivers are given several envelopes containing cash and have radios or cellphones to communicate between the dispatcher and User/Client, and are assigned specific routes.

The User applies for the services using a telephone, cellphone, computer, radio, or other communication device and upon assessment of the User's qualifications to use the “Worldwide Money Express Service”, the Service Provider then informs the User if he or she qualifies and a “Customer Account Number” is assigned to the User or Customer and a monthly “Services Access Fee” is charged to the User immediately after signing up. The Service Provider then gives the User a specific time-frame when the User can begin to use the service.

The User can be in any part of the world and request the Service Provider to deliver a specific amount of money to him or her at a specified address or to send the requested money to someone else who is not a customer or client of the Service Provider.

The Service is flexible and enables users to access their monies from any account in real-time and have the monies delivered to them within a short period of time, say 15 minutes, without the need for the Users to visit their banks, credit unions, other financial institutions, A.T.M. locations or a Western Union or MoneyGram office or store to get cash.

The “Worldwide Money Express Service” basically covers areas of money distribution that involves delivering cash and other financial instruments to Users upon request and satisfying a critical need to save the User time and money by taking the task of driving back and forth to financial institutions away from the User.

The “Worldwide Money Express Service” is a method of doing business which essentially involves person-to-person exchange of physical cash, money, or other financial instruments using electronic and other media to arrange the transaction. It is a convenient, fast, time-saving, secure and safe way of exchanging money which takes away some of the stress of everyday life from the end User or Client.

It is specifically a Door-to-Door cash delivery system to individuals and institutions wherever they may be at any point in time, day or night.

What I claim as my invention are the following:

1. A method of doing business in the money distribution and financial services industry where a User of the “Worldwide Money Express Service” can simply pick up a telephone, cellular phone, pager, computer or any other device of communication and request for a specific amount of money to be hand-delivered to him or her in person at a specified location, for example, at home, office, workshop, hotel, outdoors or wherever they may be in any part of the world. The money so requested is then delivered directly to the User in person by an independent licensed driver using an automobile, motorcycle, bicycle, horseback or any other form of transportation, who is part of a driving pool or network. Before or after the delivery, the requested amount plus a fee is electronically or physically deducted from the User's bank account, credit card account or any other financial account provided by the User to the “Worldwide Money Express Service” provider's database to ensure the delivered amount is fully recovered. The drivers can also pick up checks from the Users and deliver monies door-to-door in residential, commercial, industrial and outdoor areas.

2. A method of doing business in the money distribution and financial services industry where a User can use a telephone, cellular phone, pager, personal computer or any other communication device to request a Service Provider to send money to a third-party who is either a friend, relative or business associate at a different location and the money is hand-delivered to the beneficiaries in person wherever they may be by independent licensed drivers using any form of transportation and the amount plus a fee is electronically or physically deducted from the User's bank or other money account by the Service Provider or a check is collected from the User by a driver in person. The User can also physically receive money from the Service Provider if requested by another person using the service. The identity of the receiver must be established before money is handed over to him or her by the delivery driver.

3. A method of doing business in the money distribution and financial services industry where a User can use a telephone, cellular phone, pager, personal computer, facsimile or any other communication device to request for a personal or business loan from the Service Provider and the loan is approved and the money is physically hand-delivered to the User at a specified address in any part of the world and the amount delivered plus fees is electronically or physically deducted installmentally over a period of time.
